(19) United States
(12) Patent Application Publication
(10) Pub. No.: US 2018/0373781 A1
(43) Pub. Date: Dec. 27, 2018

(54) DATA HANDLING METHODS AND SYSTEM FOR DATA LAKES

(71) Applicant: Yogesh PALRECHA, Rockaway, NJ (US)

(72) Inventor: Yogesh PALRECHA, Rockaway, NJ (US)

(21) Appl. No.: 16/013,943

(22) Filed: Jun. 21, 2018

Related U.S. Application Data
(60) Provisional application No. 62/523,055, filed on Jun. 21, 2017.

(51) Int. Cl. G06F 17/30; G06F 9/54; G06F 17/10; G06F 15/18

(52) U.S. Cl. CPC G06F 17/30604; G06F 9/547; G06F 15/18; G06F 17/30997; G06F 17/10; G06F 17/30994

(57) ABSTRACT

Embodiments provide data handling methods and systems for data lakes. In an embodiment, the method includes accessing a plurality of data elements from a data lake associated with an organization. Each data element is registered with one or more metadata objects through a metadata registration The metadata registration is performed using a graphical user interface by either receiving a manual input from a user or using a REST application programming interface. A unified metadata repository is formed based on the metadata registration of the plurality of data elements. Moreover, complex computations of the plurality of data elements for various data processing operations and business rules are performed. Graphical processing of the plurality of data elements in the data lake is performed for analyzing entities and their relationships to generate insights. The method further includes performing an analytical operation based at least on machine learning algorithms and deep learning techniques.

### TECHNICAL FIELD

The present technology generally relates to data management and analytics applicable to wide variety of organizations and, more particularly, to methods and system for handling data of data lakes present in organizations.

### BACKGROUND

Generally, data is crucial for any business enterprise or organization, which is the key to operate and grow a business. Presently, business enterprises invest huge effort and resources on massive amounts of data collection from various sources. Some examples of various sources for data may include customer or employee data, transactional data, accounts data, system logs, emails, financial organizations, governance and regulatory bodies, social media data, sensors/IoT devices, field data, experimental data, survey data, and/or the like. The collected data from various sources may be stored without changing the natural form in a storage system. The data is collected in data lakes, which enable to take in information from a wide variety of sources. The data lakes are gathered together in a single data lake repository (hereinafter referred to as ‘organization data lake’).

Over time, the amount of data may result into forming various data lakes and the data lakes may keep on expanding in terms of volume of data present therein. Also, the data in the data lakes may vary according to different enterprises, which may commonly include information but not limited to analytic reports, survey data, log files, customer, account and transaction details, .zip files, old versions of documents, notes, inactive databases and/or the like. Within the data lakes, a large amount of data may have relevant information or values for the businesses or stakeholders, and which may contain valuable information.

Most organizations today are facing challenges in managing data within the data lakes ranging from terabytes to petabytes within an ecosystem of the organization. The existing system of data processes, which may include data ingestion, multiple data integration, data quality evaluation, data analytics process or any such data processing, affects efficiency of a data management system. For example, in an ecosystem, data from new data sources are rapidly ingested in the enterprise data lakes for enabling users to instantly access the data.

Manually extracting values from the data lakes may be cumbersome and unfeasible. Moreover, lack of information of data elements and their relationships within the data lakes, entail difficulty to extract values. The raw data in the data lakes comes from disparate systems and lacks proper structure or format, which increases complexity to integrate structured and unstructured data. Most of the enterprises commonly adopt frameworks and systems with an ability to store very large amount of raw data, which may include Apache™ Hadoop®, IBM® Watson™, DeepDive™ or the like for extracting value from the data lakes. However, the ability to store large data in the existing data management system causes bigger data lakes, which complicates in handling dynamically growing unused data.

Accordingly, there is a need for a method to overcome difficulty in handling large volumes of data in data lakes and facilitate a technique to harness different types of data for extracting relevant information or values for any business enterprise or organization, while preventing the size of data lakes from outgrowing.

### SUMMARY

Various embodiments of the present invention provide systems, methods, and computer program products for facilitating data handling for data lakes within organizations.

In an embodiment, a method is disclosed. The method includes accessing, by a processor, a plurality of data elements from a data lake associated with an organization. The method includes performing, by the processor, a metadata registration of the plurality of data elements, where the metadata registration includes registering each data element with one or more metadata objects. The metadata registration is performed using a graphical user interface either by receiving a manual input from a user or using a REST application programming interface (API). The method includes forming, by the processor, a unified metadata repository based on the metadata registration of the plurality of data elements. The method includes performing, by the processor, a graphical processing of the plurality of data elements for analyzing entities and relationships among the entities to generate insights. Some examples of the entities include customers, accounts, etc. in the field of banking. The method further includes performing, by the processor, an analytical operation based at least on one or more machine learning algorithms and one or more deep learning techniques.

In another embodiment, an analytic platform for managing a data lake associated with an organization is disclosed. The analytic platform includes a memory comprising executable instructions and a processor configured to execute the instructions. The processor is configured to at least access a plurality of data elements from the data lake associated with the organization. The processor is configured to perform a metadata registration of the plurality of data elements, the metadata registration comprising registering each data element with one or more metadata objects. Based on the metadata registration of the plurality of data elements, the processor forms a unified metadata repository. The processor is configured to perform complex computations of the plurality of data elements for data processing operations and business rules. The processor is further configured to perform a graphical processing of the plurality of data elements for analyzing entities and relationships among the entities to generate insights. Some examples of the entities include customers, accounts, etc. in the field of banking. Furthermore, an analytical operation is performed by the processor based at least on one or more machine learning algorithms and one or more deep learning techniques.

In yet another embodiment, a data lake management system in an organization is disclosed. The data lake management system includes a plurality of data lakes, an analytic platform, a memory comprising data management instructions and a processor configured to execute the data management instructions. Each data lake in the plurality of data lakes includes data elements sourced from a plurality of data sources. The processor is configured to perform a method comprising accessing a plurality of data elements from a data lake associated with an organization. The method includes performing a metadata registration of the plurality of data elements with an organization. Based on the metadata registration of the plurality of data elements a unified metadata repository is formed. The method includes performing complex computations of the plurality of data elements for data processing operations and business rules. The method further includes performing a graphical processing of the plurality of data elements for analyzing entities and relationships among the entities to generate insights and performing an analytical operation based at least on one or more machine learning algorithms and one or more deep learning techniques.

Other aspects and example embodiments are provided in the drawings and detailed description that follows.

### BRIEF DESCRIPTION OF THE FIGURES

For a more complete understanding of example embodiments of the present invention, reference is now made to the following descriptions taken in connection with the accompanying drawings in which:

FIG. 1 illustrates an example representation of an environment, where at least some embodiments of the present disclosure can be implemented;

FIG. 2 illustrates a simplified example representation of an analytics platform for managing a data lake associated with an organization, in accordance with an example embodiment of the present disclosure;

FIG. 3 illustrates a simplified example representation of metadata registration of a plurality of data elements in an organization data lake, in accordance with an example embodiment of the present disclosure;

FIG. 4 is an example block diagram representation of a unified metadata repository, in accordance with an example embodiment of the present disclosure;

FIG. 5 is a simplified example representation of metadata objects of an application, in accordance with an example embodiment of the present disclosure;

FIG. 6 is a simplified example representation of visualizing metadata objects into a network graph in a metadata navigator displaying one or more dependencies among the metadata objects, in accordance with an example embodiment of the present disclosure;

FIG. 7 is a simplified example representation of data pipeline and lineage determined by the analytics platform, in accordance with an example embodiment of the present disclosure;

FIG. 8 illustrates a flow diagram depicting a method for managing a data lake associated with an organization by an analytics platform, in accordance with an example embodiment of the present disclosure;

FIG. 9 illustrates a representation of a sequence of operations performed by the analytics platform for managing a data lake associated with an organization, in accordance with an example embodiment; and

FIG. 10 is a simplified block diagram of a data lake management system for managing the analytics platform, in accordance with an example embodiment.

The drawings referred to in this description are not to be understood as being drawn to scale except if specifically noted, and such drawings are only exemplary in nature.

### DETAILED DESCRIPTION

In the following description, for the purposes of explanation, numerous specific details are set forth in order to provide a thorough understanding of the present disclosure. It will be apparent, however, to one skilled in the art that present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

In many example scenarios, a plurality of data elements are collected in a data lake associated with an organization. The plurality of data elements may be associated with a wide variety of data sources. Moreover, the plurality of data elements may include relevant information or values that may be useful to the organization. However, manually processing and managing the data in the data lakes may be cumbersome and unfeasible. For instance, in one scenario, amount of the data in the data lake may outgrow the data lake with due course of time causing difficulty to harness the plurality of data elements. In another scenario, the plurality of data elements may vary according to different organizations causing difficulty in managing the data lake. For example, the plurality of data elements may include structured, semi-structured or unstructured data that may be difficult to integrate in managing the data lake. As the plurality of data elements from different data sources become voluminous in the data lakes, there is a need to manage the data in an efficient and secure manner.

Various example embodiments of the present disclosure provide methods, systems, and computer program products for facilitating data handling for data lakes associated with an organization that overcome above-mentioned obstacles and provide additional advantages. More specifically, techniques disclosed herein enable creating knowledge around data and capture relevant information within an ecosystem of an organization for a transparent and a secured information system.

In an embodiment, the plurality of data elements in the data lakes may be harnessed to provide high-value information for businesses or enterprises within an ecosystem and similar entities (hereinafter collectively referred to as ‘organizations’ or singularly as ‘organization’). The term organization, business or enterprise as used herein may be related to any private, public, government or private-public partnership (PPP) enterprise. The data lakes are gathered together to form a single data lake repository referred to hereinafter as an organization data lake. The organization data lake is managed and controlled by a data lake management system. In an embodiment, the data lake management system provides an analytics platform that helps in overcoming challenges of data processing and management of data lakes containing a voluminous plurality of data elements. The analytics platform is applicable for any kind of organization and can be integrated to an existing analytics platform associated with the organization. The integrated platform may be collectively referred to as ‘organization analytics platform’. The organization analytics platform is relevant to the organization in terms of development, functionality, or services provided to customers. In an embodiment, the organization analytics platform manages the plurality of data elements based on each data element registered with one or more metadata objects through a metadata registration. The plurality of data elements registered with the one or more metadata objects are stored in a unified metadata repository. In some example embodiments, the organization analytics platform enables in tracking underlying data processes in a business through the unified metadata repository and various data processing modules in the organization analytics platform. The unified metadata repository is crucial for handling the data lakes. The unified metadata repository facilitates in performing data processing operations on the plurality of data elements in the data lake. The data processing operations include a data discovery process, a data profiling process, a data quality checking process, a data reconciliation process, and a data preparation process.

The various data processing modules in the organization analytics platform facilitate in handling complex computations, graphical processing and high-end advanced analytics of the plurality of data elements. The complex computations include deriving new data elements and creating canonical datasets for a downstream data analysis based on data in the data lake. The graphical processing includes visualizing and interacting with an underlying data element in a graphical form. The graphical form helps in analyzing entities like customer, accounts and their relationships among the entities, such as customers, accounts, etc to generate new insights. For example, customer and their payment activity can be used for creating a network graph of customers showing flow of payments between customers and for building relationships between customers with the help of transaction activities happening between them. The high-end advanced analytics is based on artificial intelligence techniques that facilitate an interactive predictive model development for abstracting underlying technology and complexities associated with technology. The interactive predictive model development enables users such as, data engineers, data analysts and data scientists in developing data pipeline and lineage as well as predictive models interactively, while precluding code development for extracting and analyzing the plurality of data elements in the data lakes. In one example embodiment, the artificial intelligence techniques may provide machine learning libraries and deep learning libraries for analyzing patterns from the plurality of data elements that can be used in prediction of future events. Furthermore, the organization analytics platform facilitates users to define business rules, create predictive models and navigate data with advance graph libraries for performing computations at scale and speed on low cost commodity hardware.

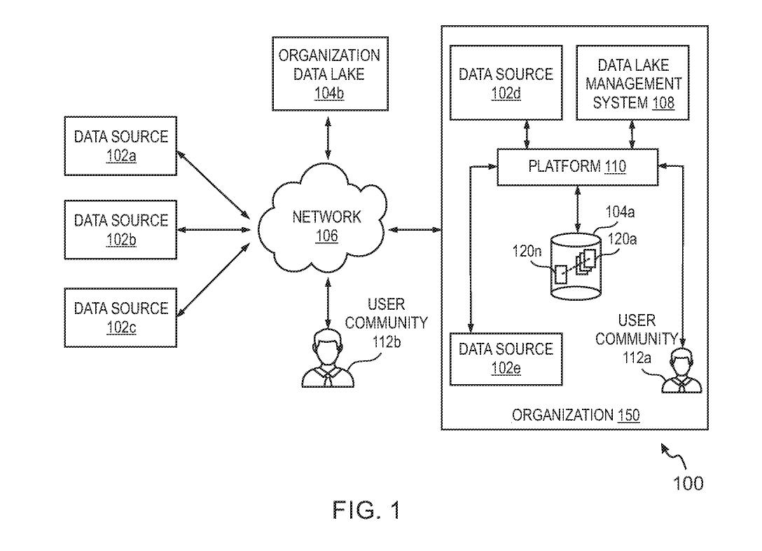

Consequently, the organization analytics platform facilitates data handling of the plurality of data elements that enable in regularly monitoring the organization data lake, while preventing data lakes from outgrowing in size. The data handling including data processing and managing of the organization data lake using the organization analytics platform is further explained in detail with reference to FIGS. 1 to 10.

FIG. 1 illustrates an example representation of an environment 100, where at least some embodiments of the present disclosure can be implemented.

The environment 100 is depicted to include an organization 150. The organization 150 may include a business or an enterprise entity belonging to a public or a private organization. A plurality of data elements received from a wide variety of data sources such as, data source 102a, data source 102b, data source 102c, data source 102d and data source 102e are gathered in data lakes. The data sources may be external or internal data sources of the organization 150, for example the data sources 102a-102c are external data sources, while the data sources 102d and 102e are internal data sources in the illustrated representation of FIG. 1. The data sources 102a-102e can be any possible source that can provide information or any kind of data to the organization 150, where the data can be directly provided by the data sources 102a-102e or it may include processed data, bi-product data, etc. Some non-limiting examples of the data sources 102a-102e may include machines at client locations, customer locations or intra-organization, financial institutions, trades, social media, governance and regulations, cloud, email servers and system logs servers. Additional examples of data sources may include sensors, Internet of Things (IoT) devices, distributed nodes, and any such network devices or wide variety of users' devices present at various geographical locations.

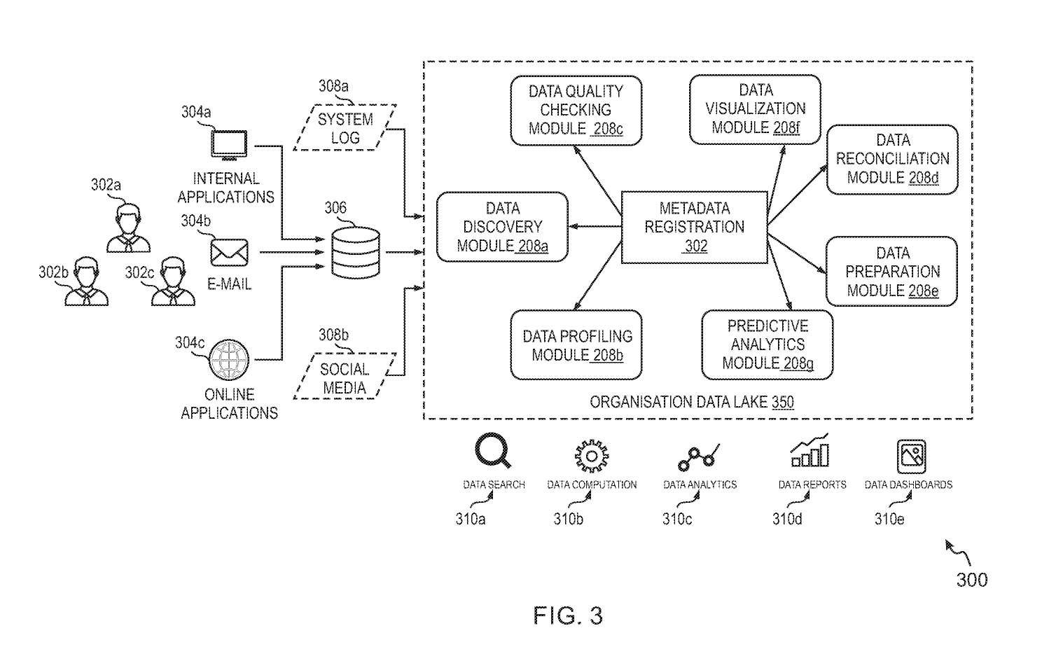

The plurality of data elements (or simply ‘data’) from the data sources 102a-102e are gathered and stored in a data lake repository such as, an organization data lake 104a and an organization data lake 104b. Each of the organization data lake 104a, 104b includes a plurality of data lakes constituted by raw or unused data of the organization 150. For instance, a plurality of data lakes is representatively shown as 120a to 120n within the organization data lake 104a. The plurality of data elements in the organization data lake 104a and the organization data lake 104b may include structured, semi-structured, unstructured, machine data or any kind of raw data. In one example embodiment, the plurality of data elements received from the data sources 102a-102e may be stored to the organization data lakes 104a and 104b via an operational system as shown in FIG. 3. The organization data lake 104a may be present as part of the infrastructure of the organization 150.

The organization data lake 104b may be present as an external part accessible to the organization 150 via a network, such as a network 106 as depicted in FIG. 1. In some implementations, the external organization data lake 104b may be a part of the cloud and/or may be a unified database or a distributed database. In some other implementations, the organization data lakes 104a, 104b may be based on various data management system or data sets such as a Relational Database Management System (RDBMS), Distributed File Systems, Distributed File Databases, Big Data, files, and/or the like. The network 106 may include wired network, wireless network or a combination thereof. Some non-limiting examples of the wired network may include Ethernet, local area networks (LANs), fiber-optic networks and the like. Some non-limiting examples of the wireless network may include cellular networks like GSM/3G/4G/5G/LTE/CDMA networks, wireless LANs, Bluetooth, Wi-Fi or Zigbee networks and the like. An example of the combination of wired and wireless networks may include the Internet or a Cloud-based network.

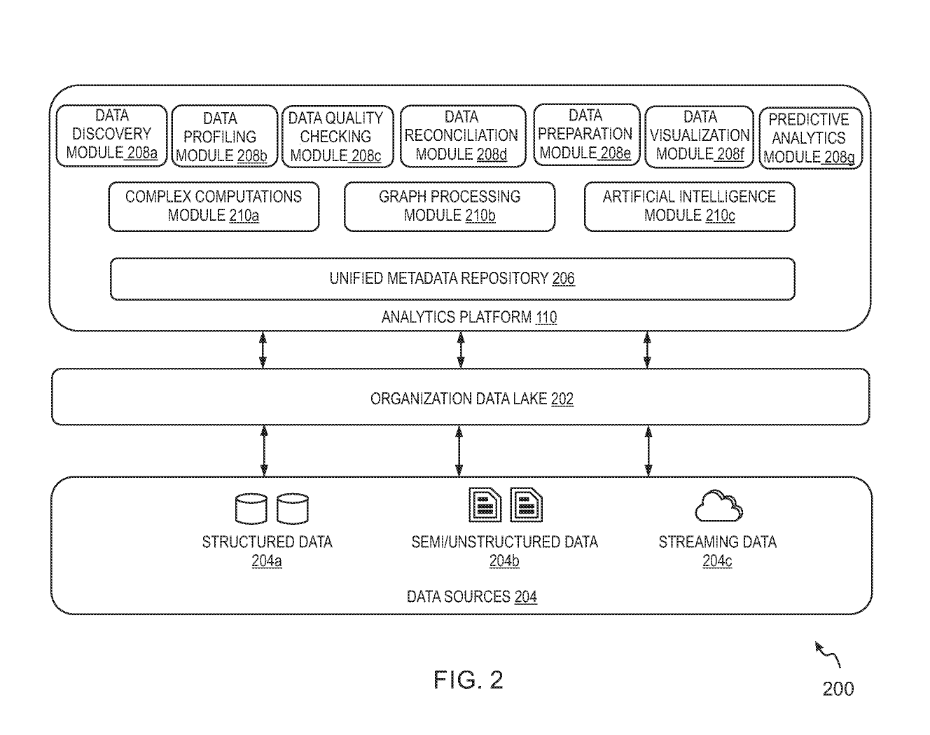

The organization 150 includes a platform 110 (hereinafter referred to as ‘an analytics platform 110’) for managing the plurality of data elements present in data lakes (e.g., 120a-120n) within the organization data lakes 104a, 104b. In various embodiments, a data lake management system 108 is configured to manage the overall operation of the analytics platform 110. The data lake management system 108 (hereinafter referred to as ‘a system 108’) may be a part of the analytics platform 110 or may be separately present within the organization 150. The analytics platform 110 is further described in detail with reference to FIG. 2. Furthermore, the analytics platform 110, controlled by the system 108, is capable of managing the plurality of data elements that help in preventing the data lakes 120a-120n in the organization data lakes 104a, 104b from outgrowing. The analytics platform 110 facilitates in performing data processing operations ranging from data discovery process to data preparation process on the plurality of data elements.

The analytics platform 110 may be used by users depicted as user community 112a, 112b in FIG. 1 or any authorized users associated with the organization 150, or can also be used by external or third party users. The user community 112a, 112b embodies system developers or data administrations (also referred to as ‘admins’) of the data lake management system 108 and customers, such as business users of the organization 150. The system developers or data admins may include information and technology (IT) engineers, data engineers, data analysts, data scientists and/or the like.

It should be appreciated that even if the data in the data lakes lack a proper structure, the analytics platform 110 is configured to integrate, manage and analyze the data of the data lakes of the organization 150. The crucial parts and data processing modules in the analytics platform 110 for processing and managing the plurality of data elements in the organization data lakes 104a, 104b are explained next with reference to FIG. 2.

Referring now to FIG. 2, a simplified example representation 200 of the analytics platform 110 (as depicted in FIG. 1) for managing a data lake 202 referred to hereinafter as organization data lake 202 associated with the organization 150 (as depicted in FIG. 1) is shown, in accordance with an example embodiment of the present disclosure.

In the representation 200, a plurality of data elements is stored in the organization data lake 202. The organization data lake 202 is an example of the organization data lakes 104a and 104b as described with reference to FIG. 1. The plurality of data elements present are associated with a wide variety of data sources 204 that may include structured data 204a, semi-structured data 204b and streaming data 204c. In one example embodiment, the structured data 204a may include data from database management systems such as Relational Database Management System (RDBMS) like Oracle®, SQL Server™. The semi-structured data 204b may include system log files, or any machine data. The streaming data 204c may include real-time data such as data from social media such as Twitter™, Facebook®, or the like.

In some example embodiments, the analytics platform 110 may be built using open source community software, which may include Apache Spark™, MongoDB™, AngularJS™, D3™ Visualization, and/or the like. Such open source software facilitates cost-effective and flexible platforms that leverage knowledge across the open source communities and organizations. In a non-limiting implementation, the organization 150 may be a cloud-based platform with the ability to run on a distributed computing architecture such as Hadoop® framework, Spark™ framework, or any framework supporting distributed computation. The distributed computing architecture enables the data lake management system (e.g., the system 108 in FIG. 1) to deploy in cloud or on-premise using suitable hardware associated with cloud applications. Such frameworks enable in breaking down the data into data chunks for managing and analyzing the data lakes efficiently.

The analytics platform 110 performs a registration of each data element with one or more metadata objects through a metadata registration. The metadata registration may be performed through in a metadata registration API. Based on the metadata registration of the plurality of data elements, a unified metadata repository 206 is formed referred to hereinafter as a unified metadata repository 206.

The unified metadata repository 206 comprises a collection of metadata objects. In one example embodiment, the metadata repository 206 includes a collection of definitions and information about structures of data in an organization, such as the organization 150 as shown in FIG. 1. Some examples of the metadata objects in the metadata repository 206 primarily include business metadata and technical metadata. Herein, the business metadata defines data, elements and usage of data within organizations, which may include business groups, sub-groups, business requirements and rules, time-lines, business metrics, business flows, business terminology and/or the like. The business metadata provides details and information about business processes and data elements, typologies, taxonomies, ontologies, etc. The technical metadata provides information about accessing data in a data storage system of an organization data lake (e.g., organization data lake 202). The information for technical metadata also includes source of data, data type, data name or other information required to access and process data in an enterprise information system. The technical metadata may include metrics relevant to IT, data about run-times, structures, data relationships, and/or the like.

The analytics platform 110 performs data processing operations on the plurality of data elements. The data processing operations include a data discovery process, a data profiling process, a data quality checking process, a data reconciliation process, a data preparation process, a data visualization process and a predictive analytics process. Subsequently, the analytics platform 110 facilitates data processing modules including, but not limited to, a data discovery module 208a, a data profiling module 208b, a data quality checking module 208c, a data reconciliation module 208d, a data preparation module 208e, a data visualization module 208f and a predictive analytics module 208g.

The data discovery module 208a helps in exploring and gathering the plurality of data elements from a variety of data sources. The data profiling module 208b examines the plurality of data elements gathered from the data sources and facilitates in gathering statistics and informative summaries about the data elements. For example, the data profiling module 208b evaluates the plurality of data elements in the organization data lake 350 to understand and determine summary of the plurality of data elements by gathering statistics of the plurality of data elements. The statistics of the plurality of data elements facilitate in determining purpose and requirement of the data in future application. Furthermore, the statistics of the data provide inputs in form of a pattern of the plurality of data elements, which can be used to create business rules for data visualization and to prepare a predictive modeling for predictive analytics.

The data quality checking module 208c assesses quality of the plurality of data elements in a context, facilitates in determining completeness and uniqueness of the plurality of data elements and enables in identifying errors or other issues within the plurality of data elements. The completeness of the plurality of data elements relies on crucial information required in a business application. For instance, in an enterprise for e-commerce, data such as customer name, customer address, contact details such as email ID or contact number, are crucial for the completeness of data. The data quality checking module 208c also facilitates in maintaining data timelines that determines data validation, accuracy and consistency in the business application. For instance, the uniqueness of a data element is achieved when the entry of data element is not duplicated and/or is not redundant with any other entry of data elements. The timelines for data provides significant importance of date and time on the data. The timelines may include information about previous transaction history of product sales or any information depended on history files. The timelines of the data further helps in determining data accuracy and consistency.

The data preparation module 208e integrates and standardizes the plurality of data elements into a standard data model. Moreover, the data preparation module 208e includes performing various data operations such as ‘joins’ for combining columns from different tables in database, data filter, calculating new fields for database, data aggregation and/or the like. In an example, in the data preparation module 208e, multiple types of data elements are integrated and standardized using an open standard format or a data interchange format.

For understanding complex data, the analytics platform 110 provides a presentation of data in a visual, pictorial or graphical representation. The data visualization module 208f enables in identifying new patterns from the visual analytics presentation. Such functionality facilitates in understanding difficult concepts and in gaining newer insights for making decisions or strategies. The predictive analytics module 208g provides an advanced analytics for making predictions about unknown future events. The predictive analytics module 208g includes using many techniques from data mining, statistics, modeling, machine learning and artificial intelligence for analyzing current data to predict about future data. The analytics platform 110 facilitates a complete lifecycle of model management i.e. creation of model, training models, predicting and simulating one or more machine learning models. In an example scenario, simulating the one or more machine learning models may include using a simulation algorithm, such as including but not limited to Monte Carlo simulation that is popularly used in a financial industry. For simulating the models, random data based on user-defined distribution of variables are generated. The models are simulated to generate a prediction based on the random data. Moreover, the analytics platform 110 enables the enterprises to stay in compliance by being able to monitor data in real-time as well as reporting activities happening within a complex ecosystem. Consequently, the analytics platform 110 facilitates in monitoring the data lakes from outgrowing in size.

The analytics platform 110 facilitates applying one or more rules on the unified metadata repository 206 for handling data processing such as complex computations, graphical processing and analytics. The one or more rules applied on the unified metadata repository 206 are implemented through processing modules comprising a complex computations module 210a, a graph processing module 210b and an artificial intelligence module 210c. In one example scenario, the complex computation module 210a may process the plurality of data elements in real-time at an efficient speed and at much lower operational cost using the one or more rules that are based upon user-defined business rule. The graph processing module 210b includes visualizing and interacting with an underlying data in a graphical form. Moreover, the graph processing module 210b helps in analyzing entities, such as customer, accounts and relationships among the entities to generate new insights. The artificial intelligence module 210c helps in analyzing and learning patterns (e.g., analytical operations) from the plurality of data elements. For instance, ability of learning the patterns from the plurality of data elements enables identifying changes in the plurality of data elements. In an example embodiment, the artificial intelligence module 210c may include one or more libraries based on one or more machine learning algorithms and one or more deep learning techniques for performing data predictive analytics. Additionally, along with computational capabilities, the analytics platform 110 facilitates in capturing business intelligence and technical metadata stored in the organization data lake 202 including, but not limited to, MongoDB™, which enables better extendibility.

It may be understood that an analytics platform such as the analytics platform 110 described with reference FIGS. 1 and 2, is associated with a data management system and can be integrated with an existing analytics platform and with existing technologies. In at least one embodiment, the organization data lake 202 may belong to an organization with associated applications and services of an ecosystem. Generally, in an ecosystem including a large-scale organization, analytics systems are built or integrated with data computing technologies. The data computing technologies may include Hadoop®, Hive™, Yarn™, Spark™ and/or the like. It should be appreciated that the analytics platform 110 can be easily integrated into such data computing technologies that prevents additional silo for data and maintenance of analytical system for data within the enterprise. The ecosystem may include customers associated with a stakeholder of the organization 150 using application and services, which may include a bank, an email service, trades, or any applications dealing with data.

The metadata registration of a plurality of data elements performed by the analytics platform 110 is explained next with reference to FIG. 3.

Referring now to FIG. 3, a simplified example representation 300 of a metadata registration 302 of a plurality of data elements in an organization data lake 350 is shown, in accordance with an example embodiment of the present disclosure. The organization data lake 350 is an example of organization data lakes 104a, 104b as shown in FIG. 1. The representation 300 is an implementation of the analytics platform 110 in an end-to-end ecosystem depicting a plurality of users, such as user 302a, 302b and 302c associated with applications and services. The applications and services for example internal application 304a, email 304b, and online applications 304c act as data sources, and corresponding data are passed to the organization data lake 350 through an operational system 306. External applications such as system log 308a and social media 308b may also contribute data in the organization data lake 350.

The operational system 306 stores and maintains records relevant to reference data of an enterprise, which may include transaction data, event-based data of a business service or any similar kind. The system logs 308a provide files with records of events, which may be obtained from an operating system, software messages, data related to system intercommunication or the like. The social media 308b provides information about cultural or seasonal trends, location information, trends of highly discussed issues, and categorized data by hash tags, or the like. Consequently, the extracted values from the organization data lake 350 using the analytics platform 110 (as depicted in FIG. 1) provides operations such as data search 310a, data computations 310b, data analytics 310c, data reports 310d and data dashboards 310e.

The metadata registration 302 of the plurality of data elements is initiated once the data elements are available in the organization data lake 350. Based on the metadata registration 302, data processing operations are performed on the plurality of data elements using data processing modules. The data processing modules include data discovery module 208a, data profiling module 208b, data quality checking module 208c, data reconciliation module 208d, data preparation module 208e, data visualization module 208f and predictive analytics module 208g, as already described with reference to FIG. 2.

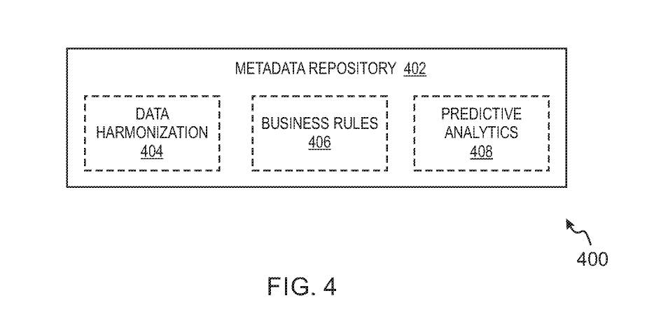

The metadata registration 302 is processed using a metadata repository such as the unified metadata repository 206 as shown in FIG. 2. The unified metadata repository 206 is explained with reference to FIG. 4.

Referring now to FIG. 4, an example block diagram representation 400 of a metadata repository 402 is shown, in accordance with an example embodiment of the present disclosure. The metadata repository 402 is an example of the unified metadata repository 206 described with reference to FIG. 2. The metadata repository 402 comprises a collection of metadata objects that facilitates in integrating a plurality of data elements based on a shared understanding, meaning and/or context. Moreover, the metadata repository 402 facilitates identifying, linking, and cross-referencing information. The identification and linking of data by the metadata repository 402 are processed to unlock the relevance and usefulness of data from the data lakes. In one example embodiment, integration of the metadata from the plurality of data sources includes aligning of various businesses and technical terms. The process of capturing and harnessing data from data lakes may be implemented in a robust and accessible manner through a metadata repository 402. The metadata repository 402 offers a unified metadata view to users in business and technical terms, which includes technical metadata, business metadata, data relationships, and data usage. The metadata view provides the knowledge and understanding of associations and relationships of data to the users in the user community 112a, 112b as depicted in FIG. 1. The ability to understand and acquire the knowledge of data relationship facilitates in sifting data through the organization data lake 350 (as depicted in FIG. 3) effectively.

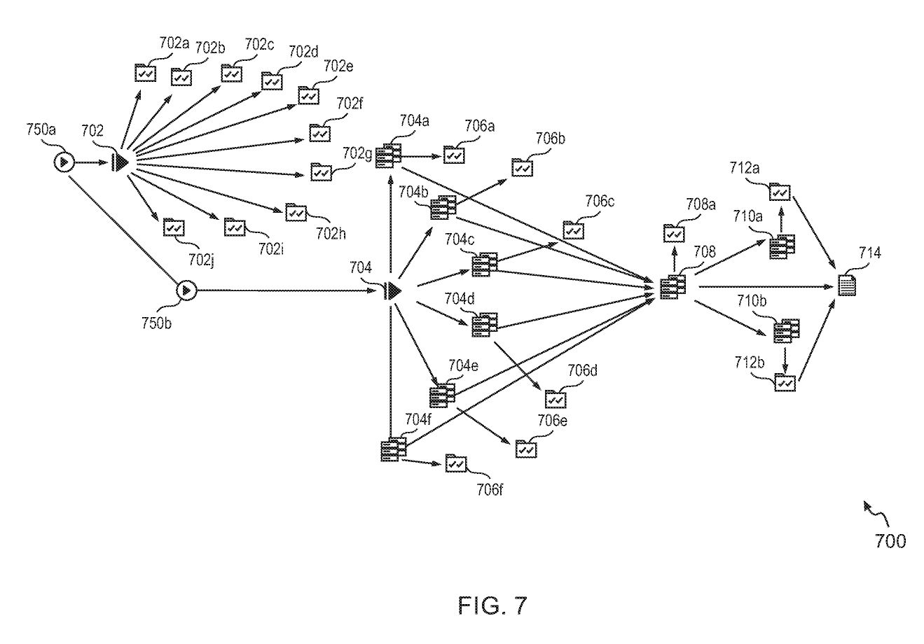

The metadata repository 402 includes metadata objects for data harmonization 404, metadata objects for introducing business rules 406 from the users and metadata objects for predictive analytics 408. The data harmonization 404 provides metadata objects for data processing operations such as data preparation, data reconciliation, data profiling and data quality of the organization data lake 350 handled by the analytics platform 110 as depicted in FIGS. 2 and 3. The data harmonization 404 also provides flow of data from a source to a destination, herein commonly referred to as ‘data pipeline and lineage’ in an enterprise. The data pipeline and lineage is used to analyze the data dependencies and the flow, which is explained further with reference to FIG. 7.

The business rules 406 in the metadata repository 402 includes a specific formal structure based on a business application. For instance, in a banking application, a business rule may include monitoring of customers, accounts, and transactions for specific behavior and events. The predictive analytics 408 may include examples such as predicting customer or account suspicious activity, suggestions to follow a person or like a page in social media, video recommendation in video websites, or any similar kind of predictions based on activity or usage by a user.

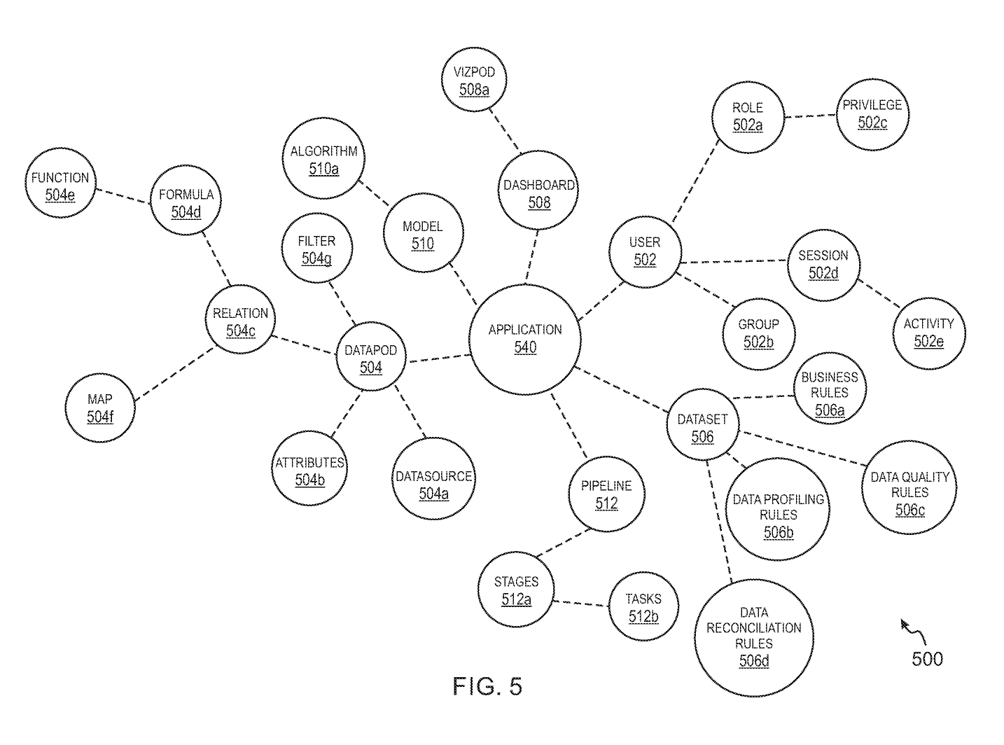

Upon performing the metadata registration, the plurality of data elements registered with the one or more metadata objects are stored in a metadata repository. The plurality of data elements registered with the one or more metadata objects is represented using metadata objects such as dashboards, datapods, vizpods, pipeline and/or the like, which is explained next with reference to FIG. 5.

Referring now to FIG. 5, a simplified example representation 500 of metadata objects of an application 540 is shown, in accordance with an example embodiment.

The application 540 is the core of the metadata with the metadata objects linked to the application 540, and each metadata object defines ownership of corresponding object in the application 540. Some examples of the metadata objects include, but are not limited to, information about users, datapods, datasets, pipeline, dashboards or any other data or concepts contributing to construction of metadata. The metadata objects are created within an ecosystem (e.g., ecosystem 300) linked to one or more applications, such as the application 540, which brings the concept of sharing the metadata objects across an enterprise, such as the organization 150 depicted with reference to FIG. 1.

In the illustrated example of the metadata system model 500, the metadata objects linked to the application 540 include, but are not limited to, User 502, Datapod 504, Dataset 506 and Dashboard 508. Each metadata objects are associated with their sub-metadata objects. For example, metadata object User 502 may include sub-metadata objects such as Role 502a, Group 502b and Privilege 502c. The metadata system models extracts (or registers) metadata corresponding to each metadata object of the application 540. For instance, User 502 metadata object corresponds to user account or profile, in which a user may be associated to groups, assign privileges according to user roles and grants the roles to sub-metadata object groups 502b for a user to perform an action. The sub-metadata objects Session 502d and Activity 502e enable auditing of objects created for keeping a track of user sessions and the corresponding activity. The user may include customers of the application 540 or user community, which help to develop the application 540. For example, the user community may include users 112a and 112b as depicted in FIG. 1 and the customers may be customers associated with applications and services 304a-304c as depicted in FIG. 3.

The metadata may be organized into a table form or as a file, which operates as a data dictionary. Every table or file is associated with one corresponding Datapod 504, which includes basic information of the table or file. The Datapod 504 is associated with Datasource 504a, which provides information about data location in an ecosystem. The information provided may be similar to database name, or schema of a database, where the data resides or physical folder location of the data. The information of each data in the Datapod 504 may include attributes, which are accessible from Attributes 504b. Each data in the Datapod 504 may be joined for transformation purposes and may share relation, which are classified in Relation 504c. The Datapod 504, the Relation 504c or any other metadata may be filtered through Filter 504g for using in various other metadata objects, which may include Dataset 506, rules such as Business Rule 506a, Data Profiling Rule 506b, Data Quality 506c and Data Reconciliation rules 506d. Moreover, formulae used for rules can be customized by using mathematical expressions through Formula 504d associated with the Relation 504c of the Datapod 504. The formulae in the Formula 504d may be functions defined in Function 504e, which may be utilized by rules 506a-506d for transforming data values.

Various functions in the Function 504e may be used to manipulate date, string, integers or any other types of data of the application 540. The attributes in the Attributes 504b from different sources may be mapped to a target through a metadata object Map 504f. The different sources of data may be from the Datapod 504, the Dataset 506, or rules from the rules 506a-506d. The target is limited to only the Datapod 504, where the data are copied. The Dataset 506 contains canonical sets of data, which are flattened data structures with optional filters, functions, formula, or the like. The Dataset 506 may be used with the rules 506a-506d, metadata object Map 504f or any similar metadata object as sources for further transformation.

The Business Rules 506a includes rules defined on the Datapod 504 or the Dataset 506 along with some criteria using information from Filter 504g to transform data or generate events. The rules enable in selecting the attributes from the Attributes 504b to be a part of results post execution. The Data Profiling Rules 506b facilitates in creating profile column data and gathering statistics such as minimum value, maximum value, average value, standard deviation, nulls or any statistical related values. The Data Quality Rules 506c are created based on the Datapod 504 and the Attributes 504b in checking quality of data for consistency and accuracy. The Data Quality Rules 506c further enables various types of checking for determining duplicate key, not null data, list of values, referential integrity, length of data, data type, or any characteristic feature of data.

The Dashboard 508 is a collection of Vizpods such as a Vizpod 508a, which enables in creating dashboard containing graphs and data grids. The Vizpod 508a includes object for the Dashboard 508, which enables configuring a chart or a data grid for display and reporting purpose. The Dashboard 508 and Vizpod 508a are driven by the Datapod 504, the Relation 504c, the rules 506a-506d, or the like. The Filter 504g may be used in the Dashboard 508 for further processing such as slicing and dicing of data.

In the Model 510, several models are used for predictive analytics purpose, where algorithms are invoked, input data are specified, parameters are passed at run time and model outputs are stored in the system. One example of algorithms is shown as an Algorithm 510a, which includes various machine-learning algorithms and deep learning techniques such as clustering, classification, regression or the like.

A Pipeline 512 is created for executing the tasks of data processing into Stages 512a. The Stages 512a execute a series of tasks, which are stored in Tasks 512b for modularization purpose. The Tasks 512b may include data mapping, data quality evaluation, data profiling, data reconciliation, predictive model creation, model training, data prediction, model simulation, which are invoked in the Pipeline 512. The Pipeline 512 enables in setting dependencies among the Stages 512a and Tasks 512b.

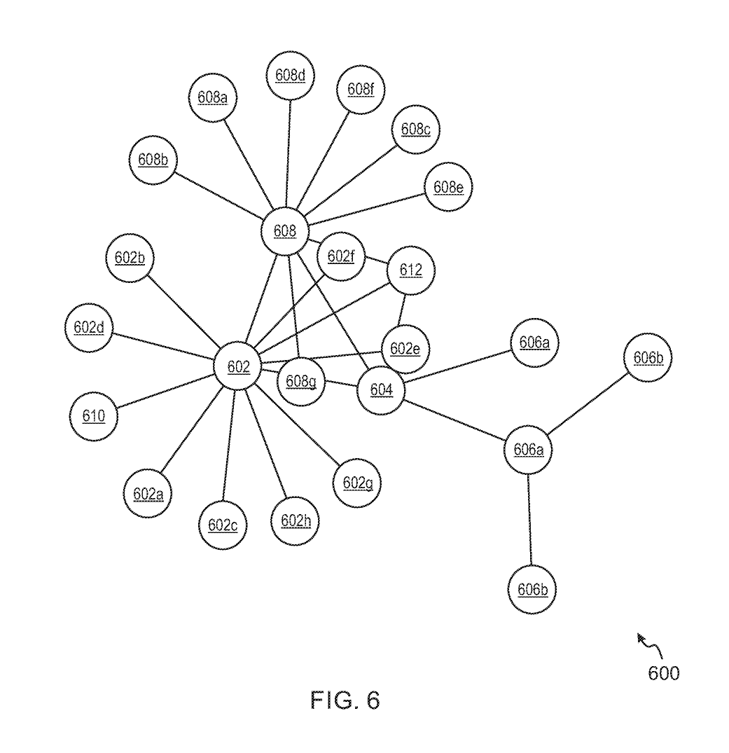

In some example embodiment, the metadata objects are configured using an open standard format, which support multiple data integration and data standardization. The open standard format includes document-based file, such as JSON or any other similar document, which provides flexibility for schema evolution to add new metadata objects or new properties to existing metadata objects. The document based file can be stored and maintained in a document-based database such as MongoDB™ or any other database supporting document based data. The process of metadata registration 302 (as depicted in FIG. 3) is initiated herein by creating the document-based file of datasets from the data lakes. The metadata objects may be configured according to the document-based file. The metadata objects are visualized in the metadata navigator in the form of a network-based knowledge graph referred to hereinafter as network graph. The document based file enables in keeping a track of changes and versions for the metadata navigator. Each node in the network graph represents a metadata object or a sub-metadata object within a metadata object. The nodes provide information, which may include identification and some basic details of the metadata objects. The metadata navigator facilitates in showing dependencies and enabling users to find dependent metadata objects in upstream and downstream direction of data transfer as explained with reference to FIG. 7. The dependencies related to historical executions of executable metadata objects are shown as well as the corresponding dependencies and metadata to a point in time version are checked. The metadata navigator corresponding to customer data of an organization is explained next with reference to FIG. 6.

Referring now to FIG. 6, a simplified example representation of visualizing metadata objects into a network graph 600 in a metadata navigator displaying one or more dependencies among the metadata objects is shown, in accordance with an example embodiment.

The metadata navigator corresponds to an application, such as the application 540 as described with reference to FIG. 5. The metadata navigator includes metadata collection in a document-based file. The document-based file includes metadata as collections, tracks different versions or changes on metadata and data elements and supports a flexible schema evolution. The metadata is represented as objects, which are designed to keep a track of changes and versions. The objects are visualized in the metadata navigator in the form of the network graph 600 of FIG. 6. Each node in the network graph 600 represents an object or sub-object within an object, which provides identification and basic details of the objects.

The network graph 600 of the metadata navigator shows dependencies and enables users to find dependent objects both upstream and downstream. The dependencies are associated with historical executions of executable objects (e.g., metadata objects map, rules, model or the like). The metadata navigator is also utilized to check the corresponding dependencies and metadata to a point in time version. Such evaluation of dependent objects is used for auditing especially in highly regulated enterprise.

The network graph 600 is a representation of an application (e.g., application 540), which is associated to an enterprise such as the organization 150 as depicted in FIG. 1. The graph nodes 602-612 in the network graph 600 may include metadata of datasets for monthly summary of customers, rules for the monthly summary of customers, relation facts of the monthly summary of customers, data warehouse application, user, analyst and admin. The graph nodes 602-612 facilitate in sifting through data in the shortest time span and in searching structural patterns in the network graph 600.

The node 602 corresponds to datasets of monthly summary of customers, which are dependent on the attribute nodes 602a-602g in the network graph 600. The attribute nodes 602a-602g are the participating attributes coming from various datapods. The attribute nodes 602a-602g are associated to the user node 604. The user node 604 includes underlying dependency nodes 606a, 606b, representing roles of analyst and admin. The node 608 associated with attribute nodes 608a-608g, provides the rules of the monthly summary of customers. The node 610 provides relation facts for monthly summary of customers for the node 602. The node 612 represents an application of a data warehouse. The dependencies within the data of an enterprise are determined by clicking on the desired nodes 602-612.

The graph nodes 602 and 608 in the network graph 600 are shown as connected with the corresponding dependencies or the metadata objects 604, 606a & 606b, 610 and 612. The node 604 represents users associated with roles such as an analyst and admin represented by node 606a and 606b respectively. The nodes are clicked to determine further dependencies within the system.

In some example embodiments, data pipeline and lineage are represented using a metadata repository, such as the unified metadata repository 206 as depicted with reference to FIG. 2. The data pipeline and lineage includes combination of information ranging from operational metadata to metadata associated with underlying rules. The data pipeline and lineage provides tracking of data flow traversing in an enterprise. The metadata based rules in the data pipeline and lineage may be defined by users. The data pipeline and lineage facilitates a visual representation of data analytic pipeline, referred to herein as workflow. The workflow represents a series of tasks performed over data in the enterprise data lakes. The tasks are grouped under data stages for modularization purpose. The tasks may include data mapping, data quality evaluation, data profiling, data reconciliation, predictive model creation, training, prediction, simulation or any relevant data process, which are invoked through the workflow. The dependencies among the tasks and stages are set with the help of the workflow. The workflow may be configured based on requirements, which enables an enterprise to customize and leverage newer technologies, while precluding difficulty of finding a technical expertise. The representation of data pipeline and lineage is explained next with reference to FIG. 7.

FIG. 7 is an example representation of data pipeline and lineage 700 determined by an analytics platform (e.g., the analytics platform 110 in FIG. 1), in accordance with an example embodiment.

The data pipeline and lineage 700 includes a sample data pipeline with two stages and a plurality of tasks in each stage along with their dependencies. Stage 1 (see, 750a) is an independent stage and will be performed as soon as the pipeline execution begins. In an example, stage 1 performs the data quality checks on various operational tables 702 (a-j) (collectively represented as ‘702’). In this example, stage 2 (see, 750b) performs the loading and data quality on each of the data warehouse tables represented as 704 (a-f) (collectively represented as ‘704’), which are independent loading tasks followed by 706 (a-f) representing the corresponding DQ tasks on each of those tables 704 (a-f). Further, reference numerals 708 and 710 (a-b) represent subsequent loading tasks dependent on successful completion of performance on data warehouse tables 704 (a-f). Furthermore, DQ on 708 and 710 (a-b) tables are performed by 708a and 712 (a-b), respectively. Thereafter, a final task 714 is a profiling task which profiles data in data warehouse dimensions dims and facts.

It should be noted that above data pipeline and lineage 700 is merely an example representation, and stages, tasks and tables can take any suitable example. Without limiting to the scope of present invention, in one application, the DQ on the operational tables 702 may be associated with sub-metadata of DQ on account 702a, DQ account type 702b, DQ address 702c, DQ bank 702d, DQ branch 702e, DQ branch type 702f, DQ customer 702g, DQ product type 702h, DQ transaction 702i, and DQ transaction type 702j. Similarly, in this specific application, the load and DQ warehouse dims and facts 704 includes sub-metadata load dim_bank 704a, load dim_branch 704b, load dim_address 704c, load dim_account 704d, load dim_customer 704e, and load dim_transaction type 704f. Further, each sub-metadata 704a-704f of load and DQ warehouse dims and facts 704 corresponds to data quality checking by DQ on dim_bank 706a, DQ on dim_dim branch 706b, DQ on dim_address 706c, DQ on dim_account 706d, DQ on dim_customer 706e, DQ on dim_transaction type 706f, respectively. The rules and facts for transaction activity is set by load fact_transaction 708, which is further associated with DQ on fact_transaction 708a. The load fact_transaction 708 is linked to load fact_account_summary_monthly 710a and load fact_customer_summary_monthly 710b. Each of the load fact_account_summary_monthly 710a and load fact_customer_summary_monthly 710b is mapped to DQ on fact_account_summary_monthly 712a and fact_customer_summary_monthly 812b, respectively. Such summaries are maintained in a profile data warehouse (e.g., represented by the final task 714).

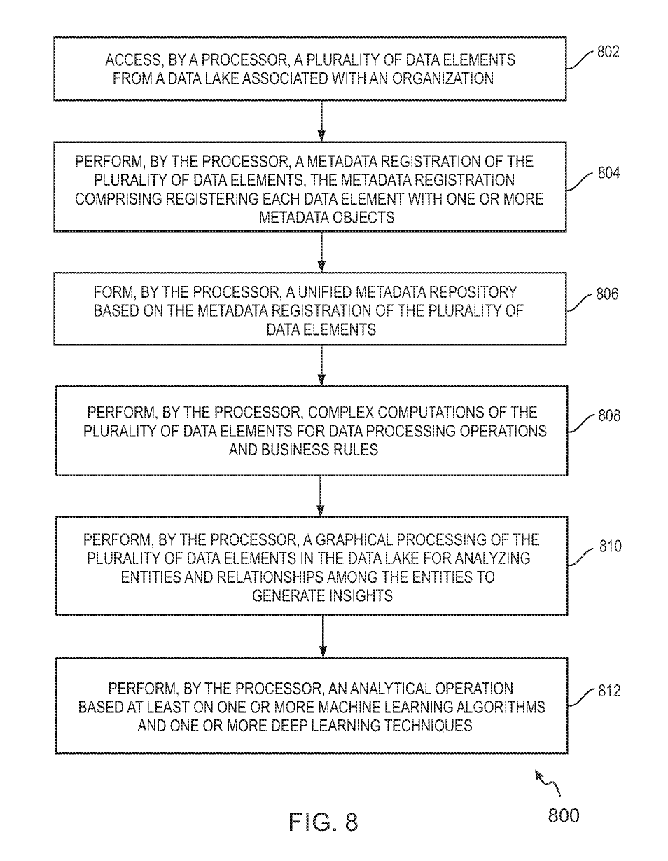

FIG. 8 illustrates a flow diagram depicting a method 800 for managing a data lake associated with an organization by an analytics platform, in accordance with an example embodiment of the present disclosure. The method 800 depicted in the flow diagram may be executed by, for example, the analytics platform 110. Operations of the method 800 and combinations of operation in the flow diagram, may be implemented by, for example, hardware, firmware, a processor, circuitry and/or a different device associated with the execution of software that includes one or more computer program instructions. The operations of the method 800 are described herein with help of the analytics platform 110. The method 800 starts at operation 802.

At operation 802, the method 800 includes accessing, by a processor, a plurality of data elements from a data lake associated with an organization. The plurality of data elements includes data from a variety of data sources that may be structured, semi-structured, unstructured, machine data or any kind of raw data. The variety of data sources may be external or internal data sources of the organization. Various data processing operations are performed on the plurality of data elements. The data processing operations include a data discovery process, a data profiling process, a data quality checking process, a data reconciliation process, a data preparation process, a data visualization process and a predictive analytics process.

At operation 804, the method 800 includes performing, by the processor, a metadata registration of the plurality of data elements. The metadata registration includes registering each data element with one or more metadata objects. The metadata registration is performed using a graphical user interface by either receiving manual input from a user, and/or using a REST application programming interface. The one or more metadata objects are visualized into a network-based knowledge graph in a metadata navigator. The metadata navigator displays one or more dependencies among the metadata objects and identifies one or more dependent metadata objects.

At operation 806, the method 800 includes forming, by the processor, a unified metadata repository based on the metadata registration of the plurality of data elements. The plurality of data elements registered with the one or more metadata objects forms the unified metadata repository. The metadata repository includes a collection of objects. The collection of objects includes properties associated with the one or more metadata objects that help in defining type of information of a data element. For instance, the unified metadata repository may include a collection of definitions and information about structures of data in an organization, such as the organization 150 described in FIG. 1. The one or more metadata objects comprise one or more business metadata objects and one or more technical metadata objects. The one or more business metadata objects provide details and information about business processes and data elements, typologies, taxonomies, ontologies, etc. The one or more technical metadata objects provide information about accessing data in a data storage system of a data lake associated with an organization (e.g., the organization data lake 202 in FIG. 2).

At operation 808, the method 800 includes performing, by the processor, complex computations of the plurality of data elements for data processing operations and business rules. In an embodiment, the complex computations of the plurality of data elements include deriving new data elements and creating canonical datasets for a downstream data analysis based on the plurality of data elements in the data lake. Moreover, the plurality of data elements may be processed in real-time at an efficient speed and at lower operational cost.

At operation 810, the method 800 includes performing, by the processor, a graphical processing of the plurality of data elements in the data lake for analyzing entities and relationships among the entities to generate insights. In an embodiment, the graphical processing includes visualizing and interacting with the plurality of data elements in a graphical form. The graphical form helps in analyzing the entities and the relationships among the entities to generate the insights. Some examples of the entities include, but not limited to, customers, accounts, transactions, etc. Based on analyzing the entities and their relationships, a graphical form such as a network graph of customers can be created for showing flow of transactions between the customers as well as for building relationships between the customers with the help of the transactions happening between them.

At operation 812, the method 800 includes performing, by the processor, an analytical operation based at least on one or more machine learning algorithms and one or more deep learning techniques. In an embodiment, performing the analytical operation includes facilitating an interactive predictive model development for developing data pipeline and lineage and determining one or more future events associated with the organization. Moreover, the analytical operation facilitates in identifying changes in the plurality of data elements. In an example, the one or more machine learning algorithms and the one or more deep learning techniques may include one or more machine learning libraries and one or more deep learning libraries for performing data predictive analytics.

The sequence of operations of the method 800 need not be necessarily executed in the same order as they are presented. Further, one or more operations may be grouped together and performed in form of a single step, or one operation may have several sub-steps that may be performed in parallel or in sequential manner.

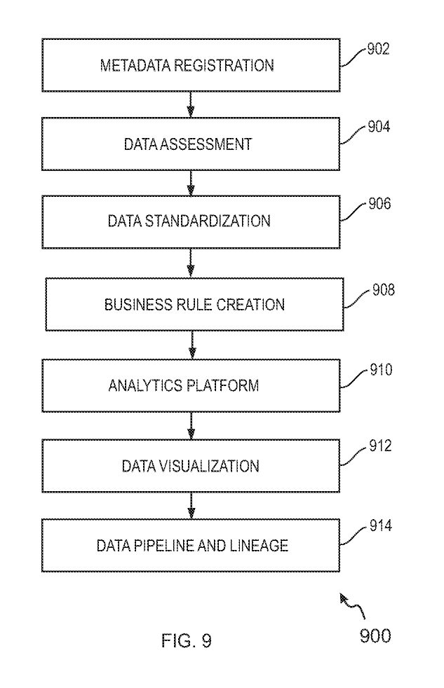

FIG. 9 illustrates a representation 900 of a sequence of operations performed by the analytics platform 110 for managing a data lake associated with an organization, in accordance with an example embodiment of the present disclosure.

At 902, a metadata registration is performed when a plurality of data elements are present in the data lake. In the metadata registration, entities and attributes associated with the plurality of data elements are registered.

At 904, after the metadata registration, a data assessment is performed on the plurality of data elements. In an example, the data assessment includes performing operations, such as data quality checking, data profiling and data reconciliation on the plurality of data elements coming from various sources before consumption by the data lake.

At 906, data standardization is performed to transform and standardize the plurality of data elements across various source systems and to prepare datasets for business rules and predictive analytics consumption.

At 908, business rules are executed by business rule engine incorporated in the analytics platform such as the analytics platform 110. The business rules are defined on datasets for record identification and for performing mathematical calculations.

At 910, the analytics platform (e.g., the analytics platform 110 as depicted in FIG. 1) calculates features and builds predictive models using one or more machine learning algorithms and one or more deep learning techniques.

At 912, one or more dashboards are created for data visualization and analytics for better understanding of business entities and their relationships.

At 914, data pipeline and lineage is created for an end-to-end automation of workflows and setting dependencies between various stages and tasks of the workflows.

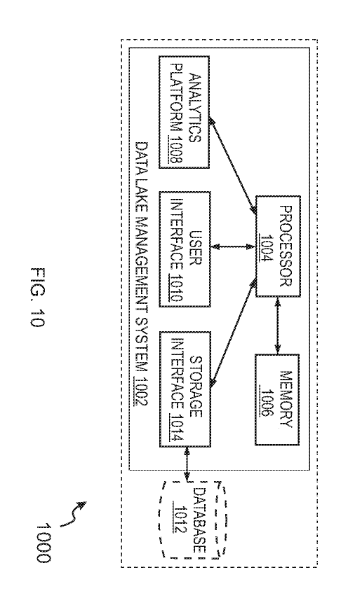

FIG. 10 is a simplified block diagram 1000 of a data lake management system 1002 for managing an analytics platform 1008, in accordance with an example embodiment of the present disclosure. The data lake management system 1002 is an example of the data lake management system 108 as shown in FIG. 1.

The data lake management system 1002 includes at least a processor 1004 for executing data management instructions. The data management instructions may be stored in, for example, but not limited to, a memory 1006. The processor 1004 may include one or more processing units (e.g., in a multi-core configuration).

The processor 1004 is operatively coupled to an analytics platform 1008 and a user interface 1010 such that the analytics platform 1008 is capable of receiving inputs from users (e.g., users 112a-112b in FIG. 1). For example, the user interface 1010 may receive data elements specified by the users for performing metadata registration by the analytics platform 1008. The analytics platform 1008 is the analytics platform 110 as described with reference to FIG. 1.

The processor 1004 is operatively coupled to a database 1012. The database 1012 is any computer-operated hardware suitable for storing data elements from a variety of data sources into data lakes. The database 1012 also stores information associated with an organization such as the organization 150 shown in FIG. 1. The database 1012 may include multiple storage units such as hard disks and/or solid-state disks in a redundant array of inexpensive disks (RAID) configuration. The database 1012 may include a storage area network (SAN) and/or a network attached storage (NAS) system.

In some embodiments, the database 1012 is integrated within the data lake management system 1002. For example, the data lake management system 1002 may include one or more hard disk drives as the database 1012. In other embodiments, the database 1012 is external to the data lake management system and may be accessed by the data lake management system using a storage interface 1014. The storage interface 1014 is any component capable of providing the processor 1004 with access to the database 1012. The storage interface 1014 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 1004 with access to the database 1012.

Various embodiments of the present invention advantageously provide data handling methods and systems, platforms for a data lake associated with an organization. The platform is a cloud ready platform, which is capable in overcoming the challenges of large data lakes constituted from data obtained from different sources. The platform facilitates in integrating and standardizing multiple types of data for performing data analytics. Various example embodiments provide predictive analytics (i.e. analytical operations) based platform driven by insightful metadata to unleash data from data lakes at scale and speed. The platform for handling the enterprise data lakes facilitates an interactive model based development, while precluding manual code development. The platform further enables users to provide business rules for an intelligent business application. The interactivity enables an integrated user experience to user community including customers or developers. The ability to provide business rules enhances better audit ability and governance in maintaining data security, which helps in managing the size of data lakes from outgrowing. In some embodiment, the platform is capable of identifying pattern of data as well as analyze data dependencies to understand relationship of data among each other. The data pattern helps to generate an advanced data visualization, which can provide information on data trends or any changes in the data.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A method, comprising:
accessing, by a processor, a plurality of data elements from a data lake associated with an organization;
performing, by the processor, a metadata registration of the plurality of data elements, the metadata registration comprising registering each data element with one or more metadata objects;
forming, by the processor, a unified metadata repository based on the metadata registration of the plurality of data elements;
performing, by the processor, complex computations of the plurality of data elements for data processing operations and business rules;
performing, by the processor, a graphical processing of the plurality of data elements in the data lake for analyzing entities and relationships among the entities to generate insights; and
performing, by the processor, an analytical operation based at least on one or more machine learning algorithms and one or more deep learning techniques.

2. The method as claimed in claim 1, wherein performing the graphical processing comprises visualizing and interacting with the plurality of data elements in a graphical form.

3. The method as claimed in claim 1, wherein performing the complex computations comprise deriving data elements and creating canonical datasets based on the plurality of data elements in the data lake.

4. The method as claimed in claim 1, wherein the metadata registration is performed using a graphical user interface by one of: receiving a manual input from a user; and using a REST application programming interface.

5. The method as claimed in claim 1, wherein the one or more metadata objects are sourced from the unified metadata repository comprising a collection of objects.

6. The method as claimed in claim 1, wherein performing the analytical operation comprises facilitating an interactive predictive model development for developing data pipeline and lineage and determining one or more future events associated with the organization.

7. The method as claimed in claim 1, wherein the data processing operations comprise:
a data discovery process;
a data profiling process;
a data quality checking process;
a data reconciliation process; and
a data preparation process.

8. The method as claimed in claim 1, further comprising facilitating provisioning of one or more rules to be applied on the unified metadata repository for performing the graphical processing or the data processing operations.

9. The method as claimed in claim 1, further comprising providing, by the processor, visualization of the one or more metadata objects into a network-based knowledge graph in a metadata navigator, the metadata navigator displaying one or more dependencies among the one or more metadata objects and identifying one or more dependent metadata objects.

10. The method as claimed in claim 9, wherein the metadata navigator facilitates configuring of the one or more metadata objects using an open standard format, the open standard format comprising a document-based file for adding metadata objects based on configuring of the one or more metadata objects.

11. The method as claimed in claim 1, wherein the one or more metadata objects comprise one or more business metadata objects and one or more technical metadata objects.

12. The method as claimed in claim 1, further comprising:
determining one or more machine learning models for data analytics; and
facilitating simulation of the one or more machine learning models.

13. An analytics platform for managing a data lake associated with an organization, the analytics platform comprising:
a memory comprising executable instructions; and
a processor configured to execute the instructions to cause the analytics platform to perform at least:
access a plurality of data elements from the data lake associated with the organization;
perform a metadata registration of the plurality of data elements, the metadata registration comprising registering each data element with one or more metadata objects;
form a unified metadata repository based on the metadata registration of the plurality of data elements;
perform complex computations of the plurality of data elements for data processing operations and business rules;
perform a graphical processing of the plurality of data elements in the data lake for analyzing entities and relationships among the entities to generate insights; and
perform an analytical operation based on at least on one or more machine learning algorithms and one or more deep learning techniques.

14. The analytics platform as claimed in claim 13, wherein to perform the analytical operation the analytics platform is further caused to facilitate an interactive predictive model development for developing data pipeline and lineage and determine one or more future events associated with the organization.

15. The analytics platform as claimed in claim 13, wherein the data processing operations comprise a data discovery process, a data profiling process, a data quality checking process, a data reconciliation process, a data preparation process, and a data preparation process.

16. The analytics platform as claimed in claim 13, wherein the metadata registration is performed using a graphical user interface by one of: receiving a manual input from a user; and using a REST application programming interface.

17. The analytics platform as claimed in claim 13, wherein the analytics platform is further caused at least in part to provide visualization of the one or more metadata objects into a network-based knowledge graph in a metadata navigator, the metadata navigator displaying one or more dependencies among the one or more metadata objects and identifying one or more dependent metadata objects.

18. A data lake management system in an organization, comprising:
a plurality of data lakes, each data lake comprising data elements sourced from a plurality of data sources; and
an analytics platform for managing the plurality of data lakes associated with the organization, the analytics platform comprising:
a memory comprising data management instructions;
a processor configured to execute the data management instructions to perform a method comprising:
accessing a plurality of data elements from a data lake associated with an organization;
performing a metadata registration of the plurality of data elements, the metadata registration comprising registering each data element with one or more metadata objects;
forming a unified metadata repository based on the metadata registration of the plurality of data elements;
performing complex computations of the plurality of data elements for data processing operations and business rules;
performing a graphical processing of the plurality of data elements in the data lake for analyzing entities and relationships among the entities to generate insights; and
performing an analytical operation based at least on one or more machine learning algorithms and one or more deep learning techniques.

19. The data lake management system as claimed in claim 18, wherein performing the graphical processing comprises visualizing and interacting with the plurality of data elements in a graphical form.

20. The data lake management system as claimed in claim 19, wherein performing the analytical operation comprises facilitating an interactive predictive model development for developing data pipeline and lineage and determining one or more future events associated with the organization.
